(19) United States
(12) Patent Application Publication
(10) Pub. No.: US 2010/0308231 A1
(43) Pub. Date: Dec. 9, 2010

(54) method and system for discrimination pulse shape

(76) Inventors: AMIN SHARGHI IDO, Tehran (IR); Seyed Mahdi Hamidzadeh, Tehran (IR)

Correspondence Address: CHOOBIN & CHOOBIN CONSULTANCY L.L.C;Barry Choobin, Green Community, Building 3, Ground Floor, Dubai Investment Park, P.O Box 212880, Dubai, AE

(21) Appl. No.: 12/479,869

(22) Filed: Jun. 8, 2009

(51) Int. Cl. G01T 1/20

(52) U.S. Cl. 250/370.11

(57) ABSTRACT

This ZCPSD Module can be used to separate neutron and gamma particles, alphas and protons, electrons and alphas etc depending on the detector used. ZCPSD provides optimum pulse shape separation for liquid scintillation counters. However the applications are not limited to n/γ separation. The ZCPSD can also be used for particle separation with inorganic scintillators, phoswitches, thick SBdetectors and proportional counters. The dc coupling allows high statistical count rate without affecting resolution, a major problem of conventional designs. The Single width NIM conforming to International Standards is easy to use, since only the anode signal is required from PM tubes. The ZCPSD can be used to generate identification spectra with a TAC and MCA or an identification signal for one species of particle.

### SPONSORSHIP STATEMENT

The present invention is sponsored by Iranian National Science Foundation for international filing.

### FIELD OF THE INVENTION

This invention relates to a method of detection and processing of pulse signals and in particular to the regulation and the discrimination of the pulse shape of the signals.

### BACKGROUND OF THE INVENTION

For the vast majority of organic scintillators, the prompt fluorescence represents most of the observed scintillation light. A longer-lived component is also observed in many cases, however, corresponding to delayed fluorescence. The composite yield curve can often be represented adequately by the sum of two exponential decays-called the fast and slow components of the scintillation. Compared with the prompt decay time of a few nanoseconds, the slow component will typically have a characteristic decay time of several hundred nanoseconds. Because the majority of the light yield occurs in the prompt component, the long-lived tail would not be of great consequence except for one very useful property: The fraction of light that appears in the slow component often depends on the nature of the exciting particle. One can therefore make use of this dependence to differentiate between particles of different kinds that deposit the same energy in the detector. This process is often called pulse shape discrimination and is widely applied to eliminate gamma-ray-induced events when organic scintillators are used as neutron detectors.

This ZCPSD Module can be used to separate neutron and gamma particles, alphas and protons, electrons and alphas etc depending on the detector used. ZCPSD provides optimum pulse shape separation for liquid scintillation counters. However the applications are not limited to n/γ separation. The ZCPSD can also be used for particle separation with inorganic scintillators, phoswitches, thick SBdetectors and proportional counters. The dc coupling allows high statistical count rate without affecting resolution, a major problem of conventional designs. The Single width NIM conforming to International Standards is easy to use, since only the anode signal is required from PM tubes. The ZCPSD can be used to generate identification spectra with a TAC and MCA or an identification signal for one species of particle.

### SUMMARY OF THE INVENTION

The principle object of the present invention is to suppress y separation rays in neutron detection systems utilizing organic scintillators. The method used is somewhat similar to a zero-crossing circuit. The main advantages of this method are its large dynamic range up to 1:500 and the feasibility of quickly checking system capabilities with minimum adjustment.

Another object of the present invention is to determine the degree of γ rejection and reproduce in a simple and straight forward manner. The circuit was especially designed for use for the neutron energies of interest range from 0.5 MeV to about 30 MeV and it Optimum particle separation for plastic liquid scintillators (NE213, BC501, BC505, NE102). In this system we use just the anode pulse of the photomultiplier for the pulse shape discrimination.

Yet another object of the present invention is to separate neutron and gamma particles, alphas and protons, electrons and alphas etc depending on the detector used. Optimum particle separation for plastic liquid scintillators (NE 213, BC 501, BC 505, NE 102).

Yet another object of the present invention is to provide a system in low level counting experiments for example: Very low level α-particle detection.

Yet another object of the present invention is to provide a system for using in X-ray proportional counter background reduction.

Yet another object of the present invention is to provide a system for Z-identification for thick surface-barrier detectors.

Yet another object of the present invention is to provide a system for Identify fission fragments in the presence of elastic background in heavy ion-induced fission reactions. (fission fragment angular distribution measurements)

Yet another object of the present invention is to provide a system for Particle identification with proportional counters and phoswitch detectors which can be directly connected to the module ZCPSD with a Constant Fraction Discriminator.

Yet another object of the present invention is to provide a system for using for hard X-ray astronomy identify with quadruple phoswitch detector.

Yet another object of the present invention is to provide a system for differentiate among various types of radiation.

Yet another object of the present invention is to provide a system for particle discriminator for the identification of light charged particles with CsI(Tl) scintillator+PIN photodiode detector.

Yet another object of the present invention is to provide a system for use in Highly sensitive measurement of α-rays in NaI(Tl) scintillators.

Yet another object of the present invention is to provide a system for Time of flight experimental setup.

Yet another object of the present invention is to provide a system to determine the relative number of neutrons and photons radiation fields for personnel dosimetry and for determination of irradiation effects on materials.

Yet another object of the present invention is to provide a system for detailed analyses of pulse shapes.

Yet another object of the present invention is to provide a system for measurement and analysis for the identification of shielded neutron sources.

Yet another object of the present invention is to provide a system for analysis of the ionization signals from germanium gamma-ray spectrometers and it's a method for obtaining information that can characterize an event beyond just the total energy deposited in the crystal.

Yet another object of the present invention is to provide a system for high resolution positron emission tomography with BGO detectors.

Yet another object of the present invention is to provide a system that is a fully dc-coupled constant fraction discriminator with a dynamic range of up to 1000:1 and PSD module Useful dynamic range up to 500:1.

Yet another object of the present invention is to provide a method for discriminating pulse shape of signal comprising: Receiving a negative anode signal from a fast photomultiplier tube, wherein said signal comprises of a rapid rise and a rapid fall time; Dividing said signal into a first sub signal which comprises of a rapid rise and a rapid fall time, and a second sub signal which comprises of a rapid rise and a rapid fall time by a linear fan out apparatus, wherein said signal is unchanged after said dividing; Inputting said first sub signal to a constant fraction discrimination (CFD) unit wherein said CFD unit consists of a predetermined parameters wherein said predetermined parameters consists of Delay: 10 nS, Fraction: 0.4 and a threshold discriminator; Obtaining a first output and a second output from said first sub signal wherein said first output is inputted in a first gate (G3) to obtain a time to amplitude converter (TAC) stop, and said second output is as a TAC start for time coincident; Inputting said second sub signal to a preamplifier (A2), wherein said second sub signal is integrated and differentiated in said preamplifier unit to obtain a semi-Gaussian bipolar signal; Feeding said semi-Gaussian bipolar signal to a high-gain limiting amplifier to obtain an amplified semi-Gaussian bipolar signal wherein zero crossing point of said semi-Gaussian bipolar signal is based on the fall time of said second sub signal; Recording said zero crossing points based on the fall time of said second sub signals; Discriminating pulse shape of said signal based on the recording of said zero crossing points.

Yet another object of the present invention is to provide signals comprising of neutron, gamma alphas, protons and electrons.

Yet another object of the present invention is to provide a method, wherein said method further comprises: Identifying fission fragments in the presence of elastic background in heavy ion-induced fission reactions.

Yet another object of the present invention is to provide a method, wherein said method further comprises: Identifying of particles with proportional counters and phoswitch detectors.

Yet another object of the present invention is to provide a method, wherein said method further comprises: measuring α-rays in NaI(Tl) scintillators.

Yet another object of the present invention is to provide a method, wherein said method further comprises: Determining of irradiation effects on materials based on number of neutrons and photons radiation fields.

Yet another object of the present invention is to provide a method, wherein said method further comprises: Measuring 226 Ra and 133 Ba using liquid scintillation counting.

Yet another object of the present invention is to provide a method, wherein said method further comprises: Pulse-shape analyzing of the ionization signals from germanium gamma-ray spectrometers.

Yet another object of the present invention is to provide an apparatus for discriminating pulse shape of signal comprising: A receiving unit for receiving a negative anode signal from a fast photomultiplier tube, wherein said signal comprises of a rapid rise and a rapid fall time; A dividing unit for dividing said signal into a first sub signal which comprises of a rapid rise and a rapid fall time, and a second sub signal which comprises of a rapid rise and a rapid fall time by a linear fan out apparatus, wherein said signal is unchanged after said dividing; A unit for inputting said first sub signal to a constant fraction discrimination (CFD) unit wherein said CFD unit consists of a predetermined parameters wherein said predetermined parameters consists of Delay: 10 nS, Fraction: 0.4 and a threshold discriminator; A unit for obtaining a first output and a second output from said first sub signal wherein said first output is inputted in a first gate (G3) to obtain a time to amplitude converter (TAC) stop, and said second output is as a TAC start for time coincident; Inputting said second sub signal to a preamplifier (A2), wherein said second sub signal is integrated and differentiated in said preamplifier unit to obtain a semi-Gaussian bipolar signal; Feeding said semi-Gaussian bipolar signal to a high-gain limiting amplifier to obtain an amplified semi-Gaussian bipolar signal wherein zero crossing point of said semi-Gaussian bipolar signal is based on the fall time of said second sub signal; Recording said zero crossing points based on the fall time of said second sub signals; Discriminating pulse shape of said signal based on the recording of said zero crossing points.

Yet another object of the present invention is to provide an apparatus further comprising: A means for identifying fission fragments in the presence of elastic background in heavy ion-induced fission reactions.

Yet another object of the present invention is to provide an apparatus further comprising: A means for identifying of particles with proportional counters and phoswitch detectors.

Yet another object of the present invention is to provide an apparatus further comprising: A means for measuring α-rays in NaI(Tl) scintillators.

Yet another object of the present invention is to provide an apparatus further comprising: A means for determining of irradiation effects on materials based on number of neutrons and photons radiation fields.

Yet another object of the present invention is to provide an apparatus further comprising: A means for measuring 226 Ra and 133 Ba using liquid scintillation counting.

Yet another object of the present invention is to provide an apparatus further comprising: A means for Pulse-shape analyzing of the ionization signals from germanium gamma-ray spectrometers.

### BRIEF DESCRIPTION OF THE DRAWINGS

FIGS. 1a-1f show a typical Applications for ZCPSD Full Zero Pulse Shape Discriminator;

FIG. 2 shows the ZCPSD block diagram;

FIG. 3 shows a typical n-g separation spectrum using Zero Cross Pulse Shape;

and FIG. 4 Figure shows of merit of ZCPSD with a 2 inch NE213 scintillator for five threshold energies.

### DETAILED DESCRIPTION OF THE INVENTION

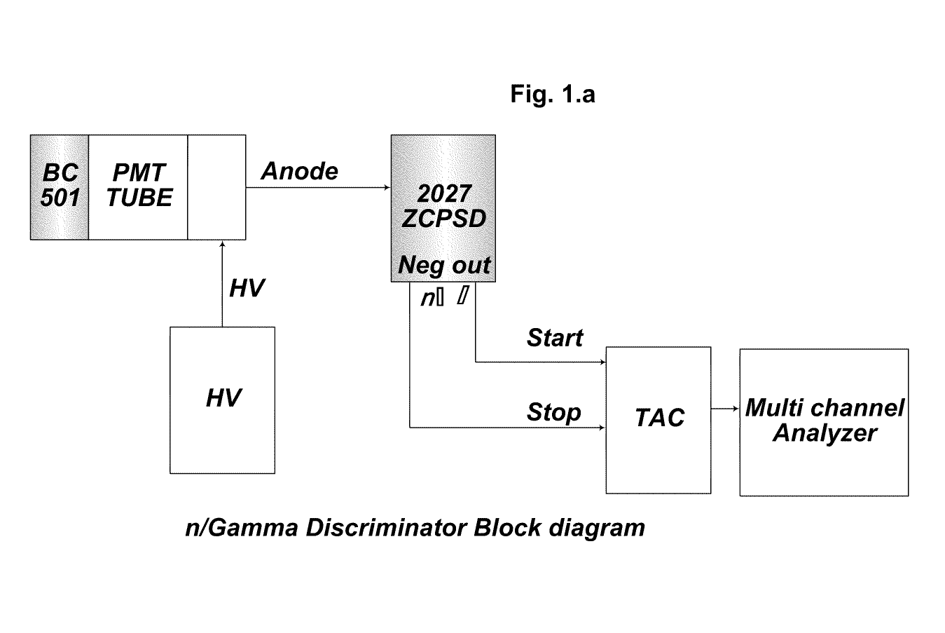

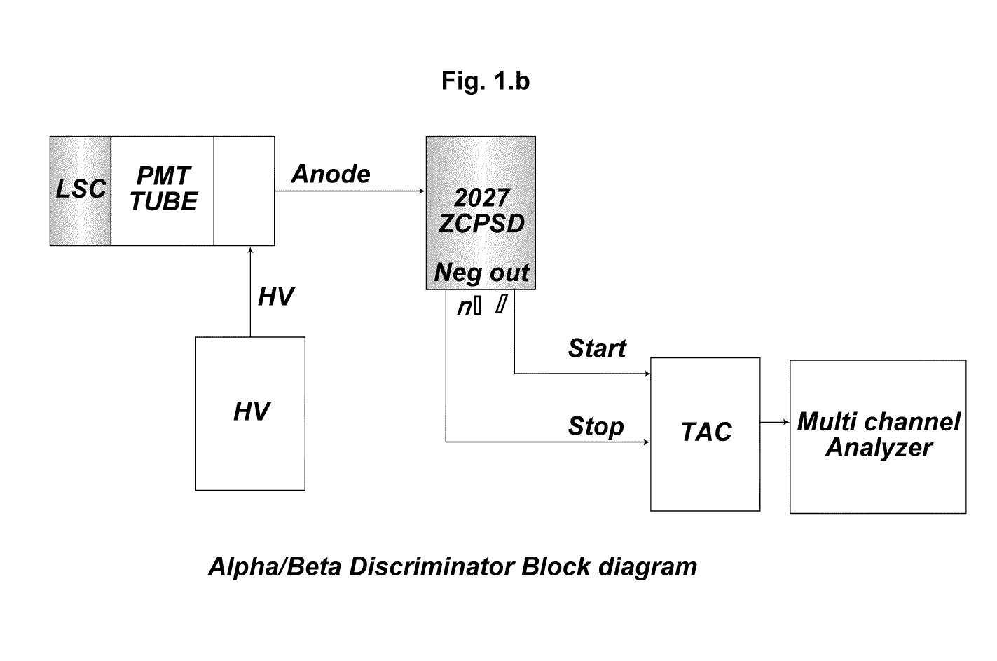

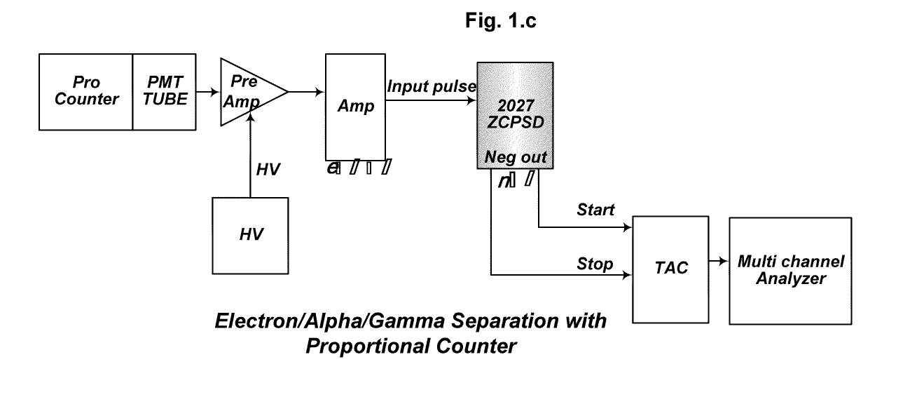

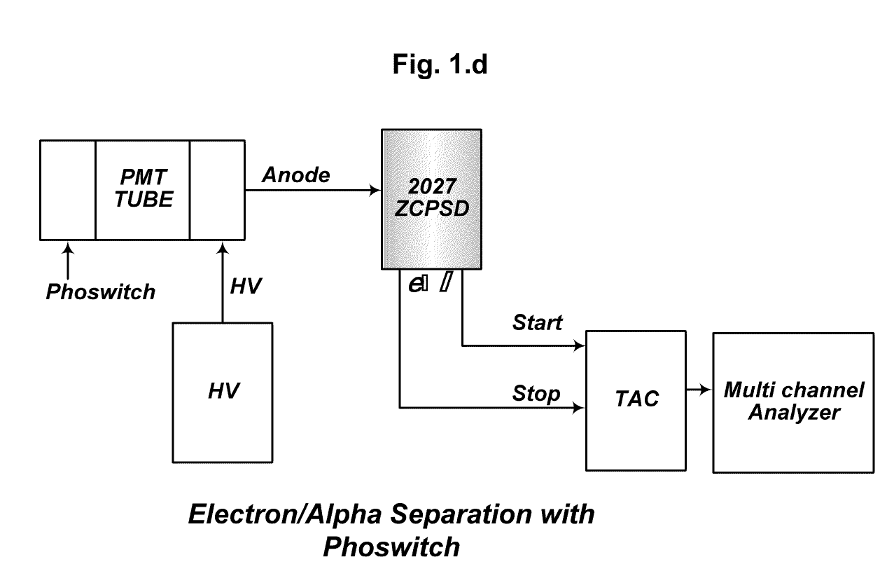

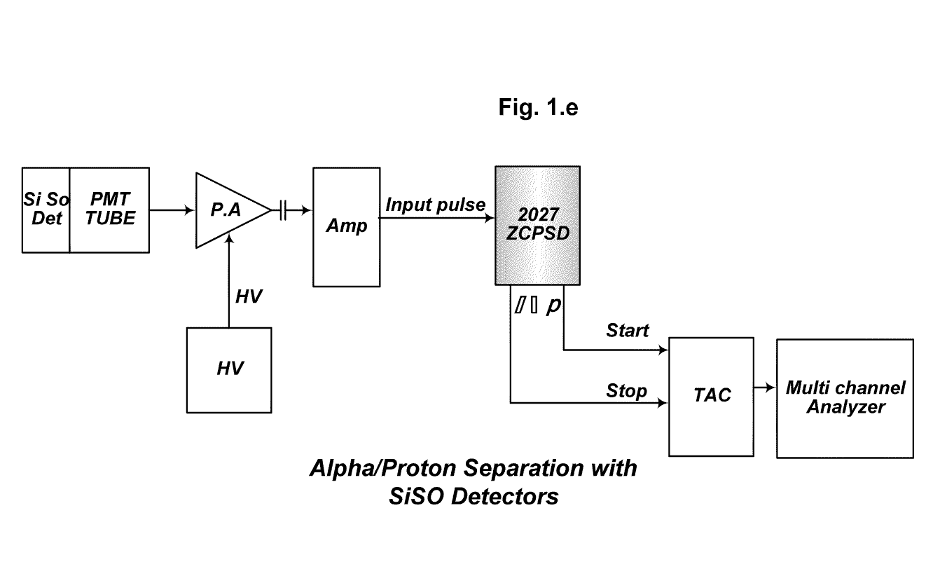

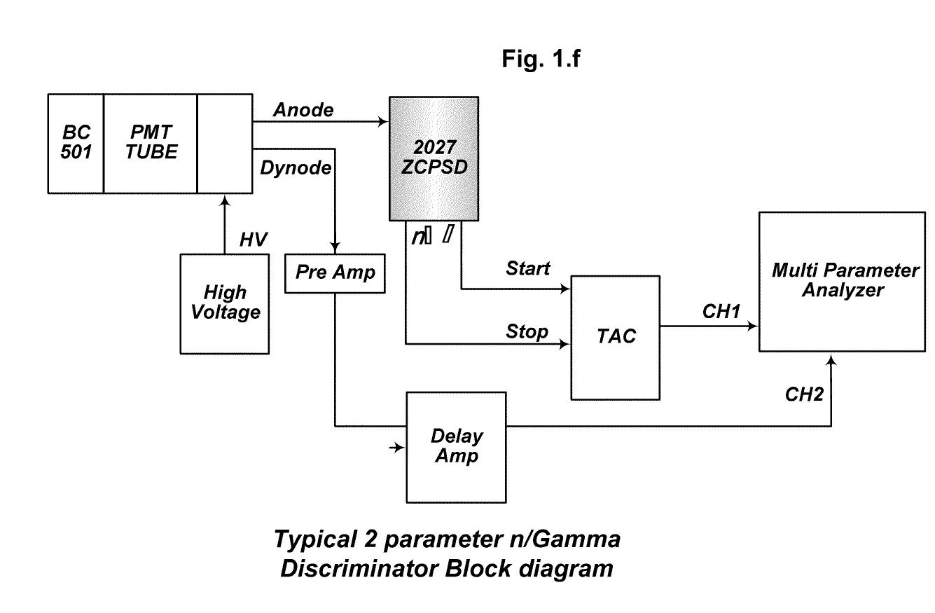

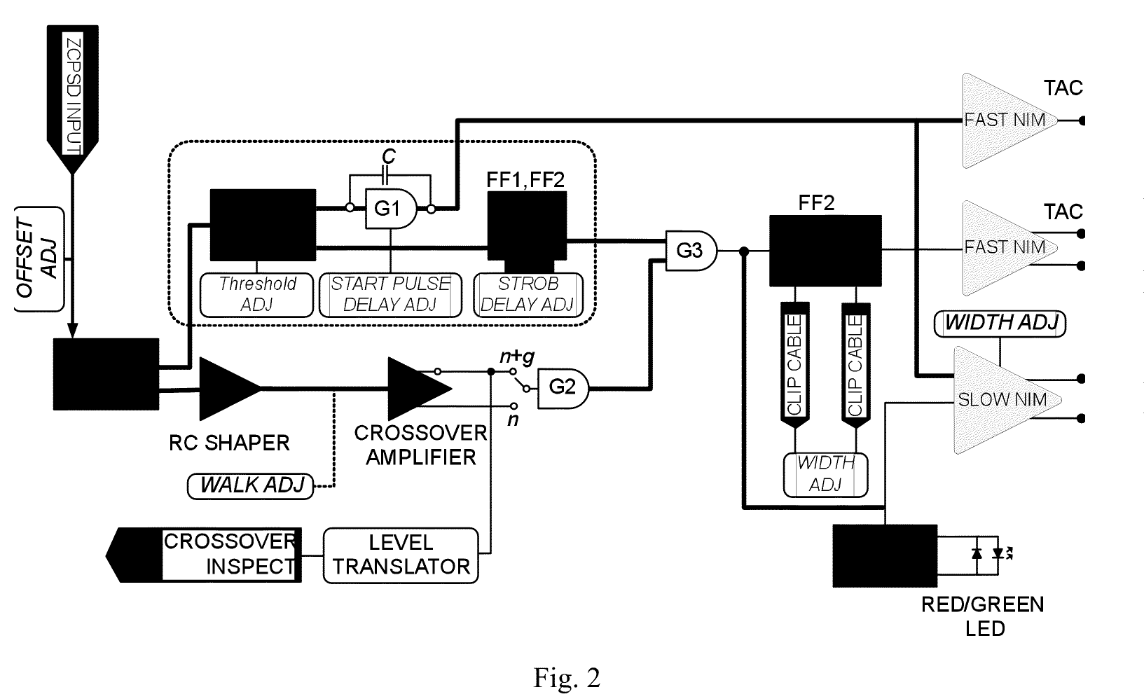

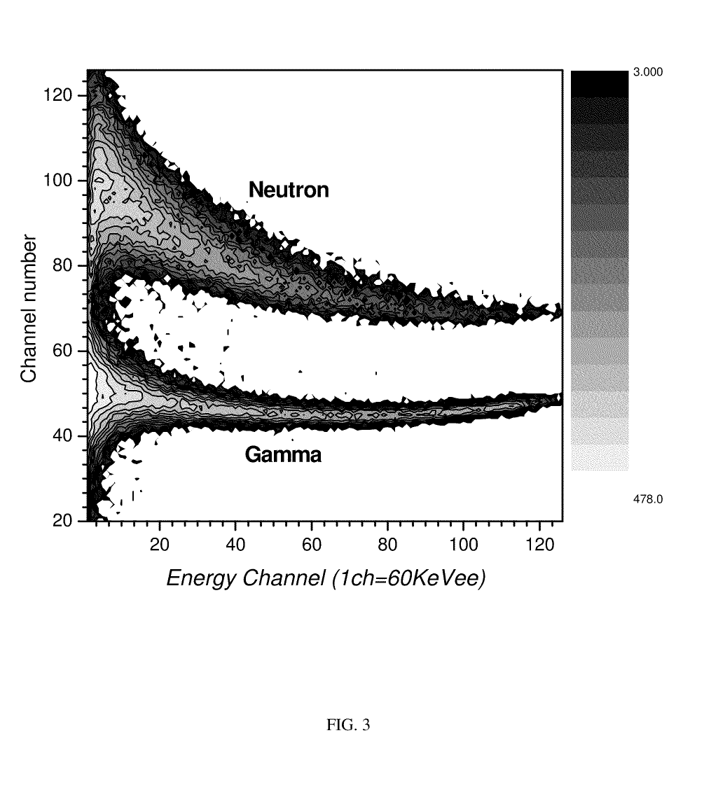

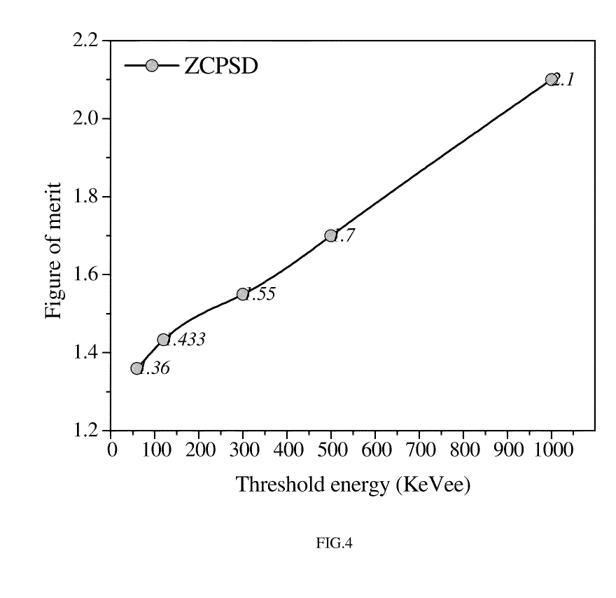

FIG. 1 shows the block diagram of the circuit. In this module, the anode signal from the fast Photomultiplier Tube (PMT) having rapid rise and fall time after one stage linear fan out is equally divided through the passive splitter and coupled to 1: CFD section(blue line) and 2: PSD section (red line)for a proper wide band impedance matching. The CFD parameters are chosen as Delay: 10 nS and Fraction: 0.4. The CFD section and Threshold discriminator section share dual ultrafast Comparator. The threshold of CFD, controlled by the screwdriver potentiometer at the front panel, determines the sensitivity threshold of all the electronics circuits. A 500 mV signal corresponds to about 5 MeV energy of recoil electrons. Adjust CFD threshold to observe signals larger than 5 mV (50 keV) to 10 mV (100 keV). This CFD provide two outputs, one of which it connected to input of FF1&FF2 block for strobe pulse of PSD. Another output after G block is fed to TAC as start pulse. G block adjusts the delay of TAC start pulse for time coincidence.

The anode pulse of the photomultiplier (PM) is integrated and differentiated in a preamplifier A2 so that the zero-crossing point of the output pulse is determined by the fall time of the input pulse. The shaped signal is then fed to a high-gain limiting amplifier A3. The signal applied to Zero Cross-Over amplifier section is suitably differentiated and integrated (˜300 nS) to realize a semi-Gaussian bipolar signal. The signal shaping is done in a cascade fashion, where the first stage is an Integrator and followed by a differentiator. Each section contains a large dynamic range, low noise, wide band frequency compensated amplifier to build signal level of required level. Thus generated bipolar signals have different zero cross over time, utilized for recording n-g separation. This signal is level limited (±10V) before further processed in a Pulse Shape Discriminator (PSD). The separation of the zero-crossing points corresponding to g or neutrons is now greatly enhanced. The overlap of the amplifier signal and the strobe pulse is formed in a gate G2 and G3. If the strobe signal is placed between the crossing points of g and neutron pulses only pulses caused by neutrons will produce an output pulse. In our Module the strobe signal is triggered by the output pulse of a constant fraction trigger (CFT), which is delayed and stretched in FF1&FF2. The generated logic signals corresponding to n-g are in fast and slow NIM standard which also utilized to START/STOB the TAC with suitable width (5 ns).

### Adjustment Procedure

### Connection to Power

The ZCPSD contains no internal power supply and must obtained the necessary DC operating power from the NIM bin and power supply in which it is installed for the operation. (+12V at 30 mA, −12V at 30 mA, +6V at 450 mA, −6V at 1.1 A)

### Connection to Photomultiplier Base

The anode signal from a photomultiplier (PMT) is sent directly to the input of the module. For the best performance of the ZCPSD, the output signal from PMT should be correspond to 1V at 50 ohm for g-rays from a 60 Co source.

### Adjustment of CFD Threshold

To adjust the CFD threshold connect the signal from the test output of the Shaping Amplifier (AMP) to the scope triggered by CFD output signal. A 500 mV signal corresponds to about 5 MeV energy of recoil electrons. Adjust CFD threshold to observe signals larger than 5 mV (50 KeV) to 10 mV (100 KeV).

### N-G Discrimination Spectrum, Adjustment of N-G Selection Delay

To adjust the unit the inverted output of A3 is used. The time relation of the g and neutron pulses at the output of the PSD unit can be monitored with a cross over inspect (A3 output) time-to-amplitude converter (TAC) (Start signal from the CFT, stop signal from the PSD) and a multichannel analyzer. Since the strobe delay is variable, the g rejection ratio can be adjusted.

At about 5 kHz counting rate the figure of merit is 1.36 for Eₒ=60 KeV and 2.1 for Eₒ=1 MeV. These values improve for lower counting rates (see FIG. 4). The time distributions are well separated and for Eₒ=1 MeV a g-rejection ratio of 1:1000 without losing neutrons is obtained.

TABLE 1
Performances

| | |
|---|---|
| Measured | Zero-crossing time distribution with Constant fraction |
| Methods | discriminator |
| n-γ discrimination | Fast and slow NIM Logic signals corresponding |
| events | to γ and neutron |
| Detector | Output of Constant Fraction Discriminator |
| Input amplitude | −5 mV to −5 volts |
| range | |
| PSD BLOCK | Volts Walk <1 nsec For 100:1 Dynamic range |
| CFD BLOCK | 100 MHz Count Rate, Walk <30 ps typically for |
| | 100:1 Range |

TABLE 2
Controls

| | | |
|---|---|---|
| CFD | threshold adj | 5 mV-1 V, Screwdriver precision potentiometer |
| BLOCK | Start pulse delay | Screwdriver precision potentiometer to control start delay |
| | adj | (100 nsec-1 μsec) |
| | Strobe delay adj | Sets strobe of Zero Crossover discriminator 30-550 ns, by |
| PSD | WALK ADJ | Sets the Zero Crossover discriminator |
| BLOCK | Negative Width adj | Rear panel external cable to widen negative outputs |
| | Positive Width adj | potentiometer 10 ns-1.5 μs, by screwdriver precision |
| | n, n + γ SWITCH | POSITION n: generates an identification signal and POSITION |
| | | n + γ generates identification spectrum. |

TABLE 3
Inputs

| | |
|---|---|
| ZCPSD | Negative current pulse from PMT anode, ≦5 V at |
| INPUT (Linear input) | 50 Ω, input impedance = 50 Ω |

TABLE 4
Outputs

| | | |
|---|---|---|
| CFD | WALK | Displays signal of zero crossing |
| | | discriminator for use in trimming time walk. |
| BLOCK | INSPECT | |
| | LEADING | Displays leading edge discriminator output. |
| | EDGE | |
| | INSEPCT | |
| | TAC START | negative current outputs, FAST NIM |
| PSD | TAC STOP | Two negative current outputs, FAST NIM |
| BLOCK | | Two positive slow NIM width adj |
| | | (10 ns-1.5 μs) Multicolor Count |
| | | Rate Indicator |

The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of the invention which is limited only by the following claims.

We claim:

1. A method for discriminating pulse shape of a signal comprising:
Receiving a negative anode signal from a fast photomultiplier tube, wherein said signal comprises of a rapid rise and a rapid fall time;
Dividing said signal into a first sub signal which comprises of a rapid rise and a rapid fall time, and a second sub signal which comprises of a rapid rise and a rapid fall time by a linear fan out system, wherein said signal is unchanged after said dividing;
Inputting said first sub signal to a constant fraction discrimination (CFD) unit wherein said CFD unit consists of a predetermined parameters wherein said predetermined parameters consists of Delay: 10 nS, Fraction: 0.4 and a threshold discriminator;
Obtaining a first output and a second output from said first sub signal wherein said first output is inputted in a first gate (G3) to obtain a time to amplitude converter (TAC) stop, and said second output is as a TAC start for time coincident;
Inputting said second sub signal to a preamplifier (A2), wherein said second sub signal is integrated and differentiated in said preamplifier unit to obtain a semi-Gaussian bipolar signal;
Feeding said semi-Gaussian bipolar signal to a high-gain limiting amplifier to obtain an amplified semi-Gaussian bipolar signal wherein zero crossing point of said semi-Gaussian bipolar signal is based on the fall time of said second sub signal;
Recording said zero crossing points based on the fall time of said second sub signals;
Discriminating pulse shape of said signal based on the recording of said zero crossing points.

2. A method as claimed in claim 1, wherein said signals comprise of neutron, gamma alphas, protons and electrons.

3. A method as claimed in claim 1, wherein said method further comprises:
Identifying fission fragments in the presence of elastic background in heavy ion-induced fission reactions.

4. A method as claimed in claim 1, wherein said method further comprises:
Identifying of particles with proportional counters and phoswitch detectors.

5. A method as claimed in claim 1, wherein said method further comprises:
Measuring α-rays in NaI (Tl) scintillators.

6. A method as claimed in claim 1, wherein said method further comprises:
Determining of irradiation effects on materials based on number of neutrons and photons radiation fields.

7. A method as claimed in claim 1, wherein said method further comprises:
Measuring 226 Ra and 133 Ba using liquid scintillation counting.

8. A method as claimed in claim 1, wherein said method further comprises:
Pulse-shape analyzing of the ionization signals from germanium gamma-ray spectrometers.

9. A system for discriminating pulse shape of signal comprising:
A receiving unit for receiving a negative anode signal from a fast photomultiplier tube, wherein said signal comprises of a rapid rise and a rapid fall time;
A dividing unit for dividing said signal into a first sub signal which comprises of a rapid rise and a rapid fall time, and a second sub signal which comprises of a rapid rise and a rapid fall time by a linear fan out system, wherein said signal is unchanged after said dividing;
A unit for inputting said first sub signal to a constant fraction discrimination (CFD) unit wherein said CFD unit consists of a predetermined parameters wherein said predetermined parameters consists of Delay: 10 nS, Fraction: 0.4 and a threshold discriminator;
A unit for obtaining a first output and a second output from said first sub signal wherein said first output is inputted in a first gate (G3) to obtain a time to amplitude converter (TAC) stop, and said second output is as a TAC start for time coincident;
Inputting said second sub signal to a preamplifier (A2), wherein said second sub signal is integrated and differentiated in said preamplifier unit to obtain a semi-Gaussian bipolar signal;
Feeding said semi-Gaussian bipolar signal to a high-gain limiting amplifier to obtain an amplified semi-Gaussian bipolar signal wherein zero crossing point of said semi-Gaussian bipolar signal is based on the fall time of said second sub signal.
